(19) United States
(12) Patent Application Publication
(10) Pub. No.: US 2023/0385714 A1
(43) Pub. Date: Nov. 30, 2023

(54) SMALL FORM FACTOR CHECK IN COMPUTE DEVICE

(71) Applicant: Astics Inc., San Mateo, CA (US)

(72) Inventors: Mrunal Desai, Santa Clara, CA (US); Ratan Hodar, San Francisco, CA (US); Chintak Desai, San Francisco, CA (US); Yogesh Thakkar, Sugar Land, TX (US)

(21) Appl. No.: 18/320,317

(22) Filed: May 19, 2023

Related U.S. Application Data
(60) Provisional application No. 63/345,082, filed on May 24, 2022.

(51) Int. Cl. G06Q 10/02

(52) U.S. Cl. CPC G06Q 10/02

(57) ABSTRACT

A compute device for use in checking in a guest at a hotel includes a touchscreen display device, an image capture device, a key management device, and circuitry configured to present a prompt for a guest to present a visual code indicative of authorization to check in to a hotel. The circuitry is also configured to receive an image of the visual code indicative of authorization to check in the guest to the hotel, determine, in response to receipt of the visual code, whether to provide one or more keys to the guest, and provide the one or more keys to the guest. The compute device is adapted to be supported above a floor of the hotel by a planar surface of a supporting structure.

### CROSS-REFERENCE TO RELATED APPLICATION

This application claims the benefit, under 35 U.S.C. § 119(e), of U.S. Provisional Patent Application No. 63/345,082, filed May 24, 2022, the entirety of which is hereby expressly incorporated by reference herein.

### BACKGROUND

The process of registering a person for a stay at a hotel is typically performed by a person who works at a front desk of the hotel. In the process, the person working at the front desk confirms the identity of the guest, determines whether one or more rooms are available in the hotel to accommodate the guest, takes payment for reserving the one or more rooms, and provides one or more keys to the guest to enable the guest to access the room(s) during the time period of the reservation. In situations in which a large number of people are seeking to reserve rooms in the hotel concurrently, such as during a convention or sporting event, multiple front desk operators may work in parallel to provide higher throughput at the front desk. Though human front desk operators have been used for decades to check in guests, staffing the front desk is inefficient and represents a multitude of costs and logistical issues to the organization managing the hotel. For example, the organization must compensate each front desk operator for their time and must quickly respond to instances in which one or more of the front desk operators cannot work due to illness, injury, or other unforeseen events. Furthermore, the hotel must be built with dedicated spaces (e.g., cubicles, desks, chairs, etc.) for each front desk operator to work at and during periods of low check in activity, many of those spaces may go unused. As such, the ability to efficiently and reliably scale up processing capacity for checking in guests is lacking in the hotel industry.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a diagram of an embodiment of a check in compute device for enabling efficient check in operations for a hotel;

FIG. 2 is a simplified block diagram of components of the check in compute device of FIG. 1;

FIG. 3 is a simplified block diagram of at least one embodiment of a system, including the check in compute device of FIG. 1, for enabling efficient check in operations for hotels;

FIGS. 4-7 are simplified block diagrams of at least one embodiment of a method for performing an efficient check in operation for a hotel that may be performed by the check in compute device of FIG. 1; and

FIGS. 8-12 are diagrams of the check in compute device of FIG. 1 performing operations in the method of FIGS. 4-7.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

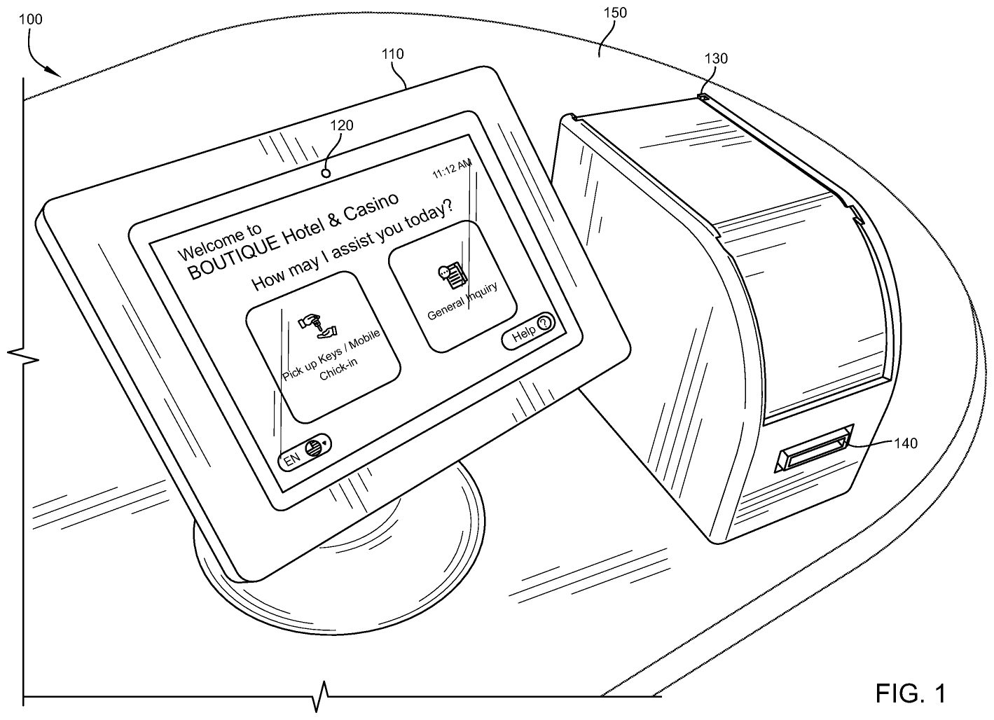

Referring now to FIG. 1, a check in compute device 100 for facilitating check in operations for a hotel includes a display device 110 communicatively coupled to a key management device 130. In the illustrative embodiment, the display device 110 includes an image capture device 120 oriented towards an area where a guest would stand to interact with the check in compute device 100. Additionally, the key management device 130 includes a slot 140 through which one or more keys, each configured to enable access to a corresponding room of a hotel, may be dispensed to the guest. As described in more detail herein, the check in compute device 100, in operation, finalizes a check in process that was initiated using a separate compute device, such as a mobile compute device (e.g., smart phone) of a guest. That is, in the illustrative embodiment, the check in compute device 100 is configured to capture an image of and decode a visual code (e.g., a quick response code (“QR code”), a bar code, etc.) displayed by the screen of the mobile compute device of the guest, indicating that a pre-check in operation is complete, verify that the guest is indeed authorized to obtain one or more keys to one or more rooms of the hotel at the present time, and provide the key(s) to the guest using the key management device 130. Unlike human front desk operators or free standing kiosks for performing electronic check in operations, both of which require dedicated spaces in which to operate, the check in compute device 100 has a small form factor, meaning that the check in compute device 100 may rest upon the surface (e.g., a planar surface 150) of a table, desk, counter, or other furniture (e.g., off the floor of the hotel and at a height (e.g., approximately waist level or higher) that enables convenient interaction with a user) and can be easily moved to make space for another check in compute device 100 if needed (e.g., to accommodate a relatively large influx of guests seeking to check in to a hotel).

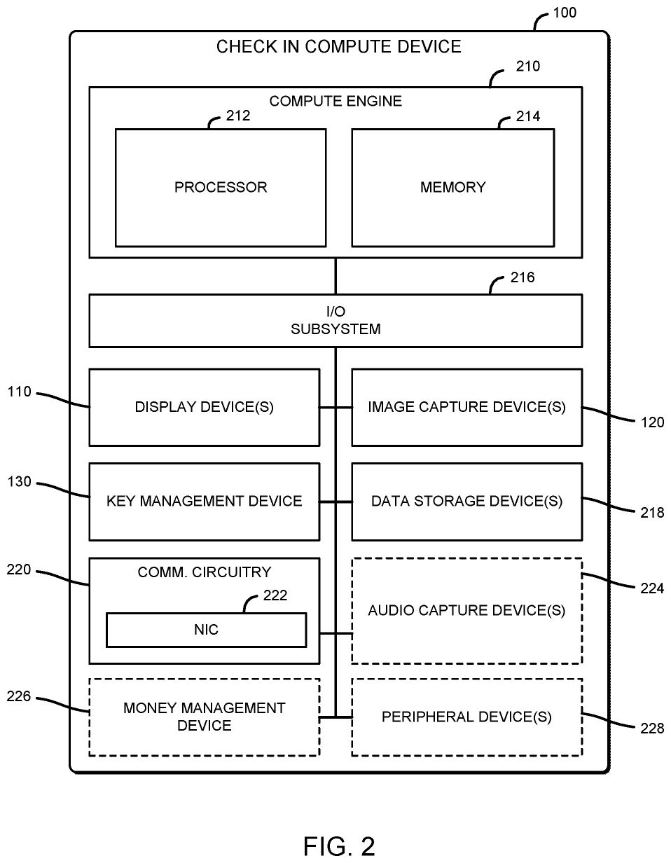

Referring now to FIG. 2, the illustrative check in compute device 100 includes a compute engine 210, an input/output (I/O) subsystem 216, the display device 110, the image capture device 120, the key management device 130, a data storage subsystem 218, and communication circuitry 220. In some embodiments, the check in compute device 100 may include additional components, such as one or more audio capture devices 224, a money management device 226, and/or peripheral devices (e.g., a physical keyboard, a mouse or trackpad, etc.). Additionally, in some embodiments, one or more of the illustrative components may be incorporated in, or otherwise form a portion of, another component.

The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as hotel identifiers, room identifiers, reservation data (e.g., hotel identifier, room identifier(s), guest identifier, and periods of time in which a reservation of the room(s) of the hotel are reserved in connection with a guest), data encoding scheme(s) for keys, payment information submitted by a guest, applications, libraries, and drivers.

The compute engine 210 is communicatively coupled to other components of the check in compute device 100 via the I/O subsystem 216, which may be embodied as circuitry and/or components to facilitate input/output operations with the compute engine 210 (e.g., with the processor 212 and the main memory 214) and other components of the check in compute device 100. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the check in compute device 100, into the compute engine 210.

The display device 110 may be embodied as any device or circuitry (e.g., a liquid crystal display (LCD), a light emitting diode (LED) display, a cathode ray tube (CRT) display, etc.) configured to display visual information (e.g., text, graphics, etc.) to a viewer (e.g., guest). The display device 110 is illustratively embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from the user (e.g., guest).

The image capture device 120 may be embodied as any type of device (e.g., a digital camera) configured to obtain visual information from the environment to be encoded in a digital form (e.g., as pixel values of an image or video) for local processing, storage, and/or transmission to another device. In the illustrative embodiment, the image capture device 120 is integrated into the same housing as the display device 110 and is oriented such that a field of view of the image capture device 120 includes an area in which a user of the check in compute device 100 (e.g., guest) would stand when interacting with the check in compute device 100, to enable the image capture device 120 to capture an image of a visual code displayed by a mobile compute device operated by the guest. The key management device 130 may be embodied as any device (e.g., an electronic device, an electromechanical device, etc.) configured to dispense one or more keys (a key card, a fob, a metal key adapted to be inserted into a door lock, etc.) to enable a guest to access a room (e.g., of a hotel). In doing so, the key management device 130 may be configured to encode an access code (e.g., a unique numeric code) in a key (e.g., on a magnetic strip of a key card, in a microchip of a key card or fob capable of transmitting data via wireless communication such as radio frequency identification (RFID) and/or near field communication (NFC)).

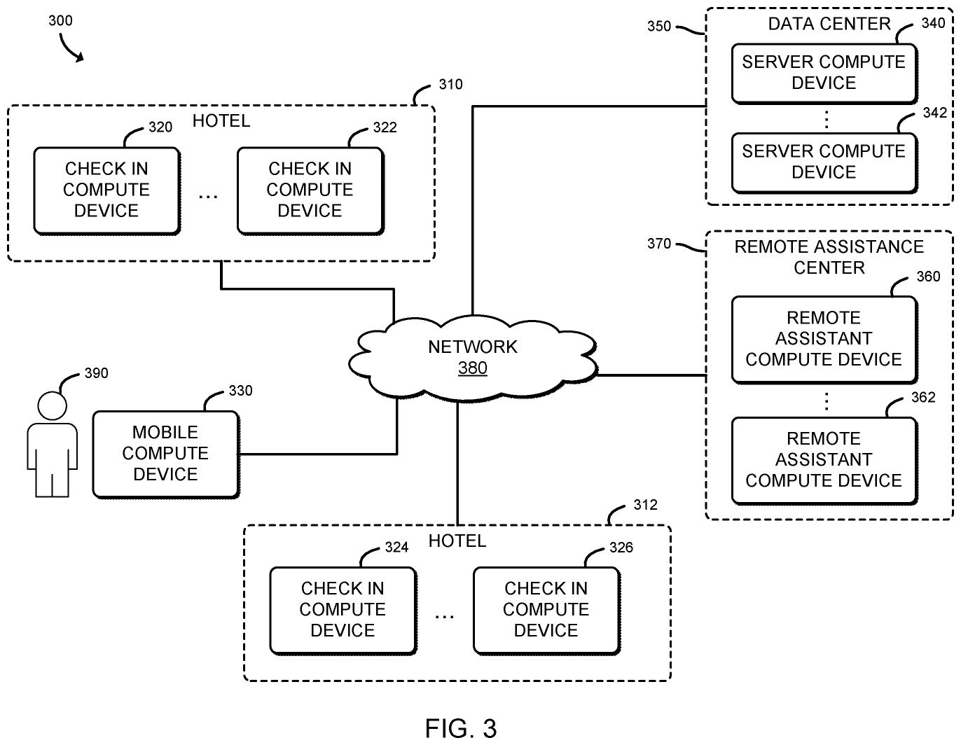

Each data storage device 218, may be embodied as any type of device configured for short-term or long-term storage of data such as, for example, memory devices and circuits, memory cards, hard disk drives, solid-state drives, or other data storage device. Each data storage device 218 may include a system partition that stores data and firmware code for the data storage device 218 and one or more operating system partitions that store data files and executables for operating systems. The communication circuitry 220 may be embodied as any communication circuit, device, or collection thereof, capable of enabling communications over a network between the check in compute device 100 and another device (e.g., a server compute device 340, 342, a remote assistant compute device 360, 362 (also referred to as a “front desk operator compute device”), and/or a mobile compute device 330 described in more detail with reference to FIG. 3). The communication circuitry 220 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 220 includes a network interface controller (NIC) 222. The NIC 222 may be embodied as one or more add-in-boards, daughter cards, network interface cards, controller chips, chipsets, or other devices that may be used by the check in compute device 100 to connect with another compute device (e.g., a server compute device 340, 342, a remote assistant compute device 360, 362, and/or a mobile compute device 330 described in more detail with reference to FIG. 3). In some embodiments, the NIC 222 may be embodied as part of a system-on-a-chip (SoC) that includes one or more processors, or included on a multichip package that also contains one or more processors. In some embodiments, the NIC 222 may include a local processor (not shown) and/or a local memory (not shown) that are both local to the NIC 222. In such embodiments, the local processor of the NIC 222 may be capable of performing one or more of the functions of the compute engine 210 described herein. Additionally or alternatively, in such embodiments, the local memory of the NIC 222 may be integrated into one or more components of the check in compute device 100 at the board level, socket level, chip level, and/or other levels.

The audio capture device 224, if present, may be embodied as any device (e.g., a microphone) configured to obtain audio information from the environment and encode the audio information into a digital form for local processing, storage, and/or transmission to another device. The money management device 226, if present, may be embodied as any device or circuitry (e.g., an electronic device, an electromechanical device, etc.) configured to receive physical currency (e.g., dollars, coins, etc.) and/or non-physical currency (e.g., information embodied on a payment card, etc.) and, in some embodiment, provide change (e.g., physical currency) in response to a determination that an overpayment has been received for an amount due (e.g., an overpayment for reservation of a hotel room). In some embodiments, the money management device 226 may be additionally configured to determine whether a payment is fraudulent (e.g., determining whether security features are present in the currency, such as a strip embedded in a dollar bill that is visible when exposed to a light, watermark(s), determining whether payment card data satisfies the Luhn algorithm, etc.). In some embodiments, the money management device may utilize or be incorporated into the image capture device 120 (e.g., to obtain images of surfaces (e.g., the front and back) of a payment card, the communication circuitry (e.g., to obtain payment data transmitted wirelessly from a payment device), and/or the key management device 130 (e.g., to read data encoded on a magnetic strip of a payment card)). However, in the illustrative embodiment, the money management device 226 is not present as all payment operations have been handled in a pre-check in process performed with one or more other compute devices (e.g., a mobile compute device of the guest, etc.).

While shown as a single unit in FIG. 2, the components of the check in compute device 100 may be located in multiple housings but communicatively coupled together (e.g., via the I/O subsystem). For example, the compute engine 210, display device 110, image capture device, data storage device 218, communication circuitry 220, and other components may be enclosed within one housing while the key management device 130 has a separate housing. Further, it should be appreciated that the check in compute device 100 may include other components, sub-components, and devices commonly found in a computing device, which are not discussed above in reference to the check in compute device 100 and not discussed herein for clarity of the description.

Referring now to FIG. 3, a system 300 for enabling efficient check in operations includes, in the illustrative embodiment, multiple hotels 310, 312, each with a corresponding set of check in compute devices 320, 322, 324, 326, similar to the check in compute device 100 described with reference to FIGS. 1 and 2. While two hotels 310, 312 are shown in the system 300, it should be understood that in other embodiments, the number of hotels may differ. Further, while two check in compute devices are shown in each hotel, it should be understood that in other embodiments, the number of check in compute devices present in the hotels may be different and may vary over time (e.g., to selectively increase or decrease capacity for processing check in operations on an as-needed basis). Additionally, the system 300 may include a mobile compute device 330 (e.g., a smart phone, a tablet, a notebook compute device, a wearable compute device, etc.) operated by a user 390 (e.g., a guest). Further, in the illustrative embodiment, the system 300 includes a set of server compute devices 340, 342 in a data center 350 as well as a set of remote assistant compute devices 360, 362 in a remote assistance center 370 (e.g., an office building). In some embodiments, the server compute devices 340, 342 may be co-located (e.g., in the same building) with the remote assistant compute devices 360, 362 and/or integrated with the remote assistant compute devices 360, 362. While two server compute devices 340, 342 and two remote assistant compute devices 360, 362 are shown, it should be understood that the number of server compute devices and remote assistant compute devices may differ in other embodiments.

In operation, and as explained in more detail herein, the system 300 performs a check in process (e.g., operation) with the user (e.g., guest) 190 without the involvement of an on-site human front desk operator (at the corresponding hotel). Rather, the user 390 performs a pre-check in operation in on the user's mobile compute device 330 (e.g., phone) in which the user 390 provides information about their identity, the hotel and room(s) to be reserved, the time period over which the reservation is to extend, and payment information. In response, the mobile compute device 330 obtains (e.g., from the server compute device(s) 340, 342, generates locally, etc.) a visual code (e.g., a QR code or bar code) indicating that the pre-check in process has been completed. At that point, information about the user 390 (guest) and the reservation is present in one or more databases of the system 300 (e.g., in the data center 350, distributed to the check in compute devices(s) 320, 322 of the corresponding hotel 310, 312, etc.) and is accessible using information encoded in the visual code (e.g., which may include a reference code (e.g., a unique key) usable to perform a query on the stored information about the reservation or which may include the reservation information itself). The process by which the pre-check in operation is performed is described in more detail in U.S. provisional patent application 63/247,421, entitled “TECHNOLOGIES FOR ENABLING EFFICIENT CHECK IN OPERATIONS FOR HOTELS” filed Sep. 23, 2021, the entire contents of which are incorporated by reference herein. Once the pre-check in operation has been completed, a check in compute device 320, 322, 324, 326, each of which is similar to the check in compute device 100 described with reference to FIGS. 1 and 2 may perform a method for completing the check in process based on the visual code, as described in more detail herein.

In the illustrative embodiment, the compute devices 320, 322, 330, 324, 326, 340, 342, 360, 362 are in communication via a network 380, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof. The compute devices 320, 322, 330, 324, 326, 340, 342, 360, 362 may have components similar to those described in FIG. 2 with reference to the check in compute device 100. The description of those components of the check in compute device 100 is equally applicable to the description of components of the compute devices 320, 322, 330, 324, 326, 340, 342, 360, 362. However, it should be noted that in the illustrative embodiment, the mobile compute device 330, the server compute devices 340, 342, and the remote assistant compute devices 360, 362 may not include certain specialize components present in the check in compute devices 100, 320, 322, 324, 326 such as the key management device 130. Further, it should be appreciated that any of the devices 320, 322, 330, 324, 326, 340, 342, 360, 362 may include other components, sub-components, and devices commonly found in a computing device, which are not discussed herein for clarity of the description.

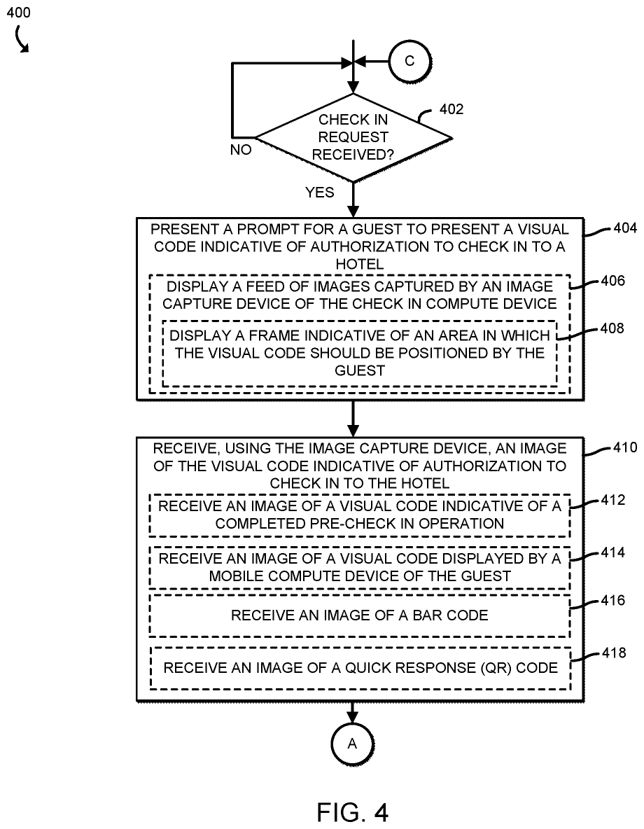

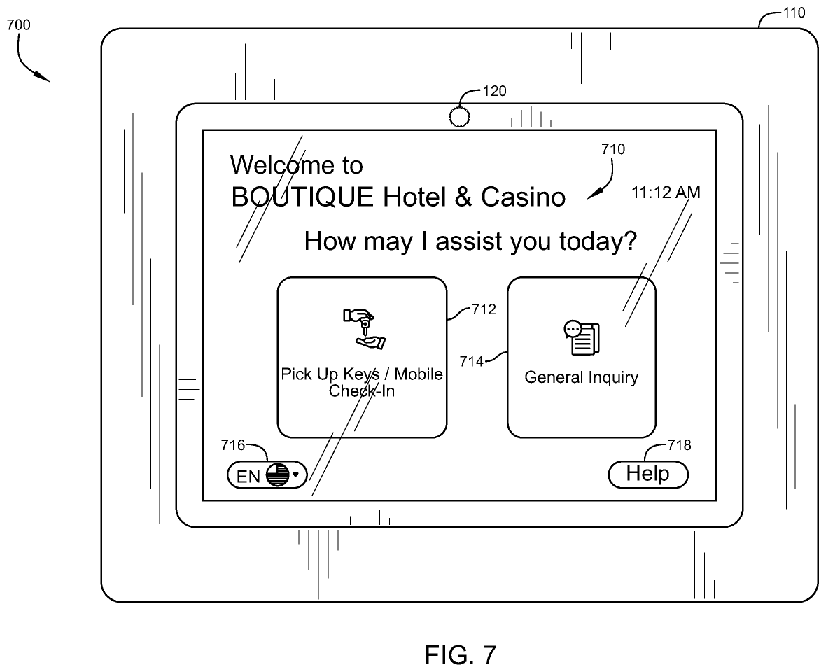

Referring now to FIG. 4, the check in compute device 100 may perform a method 400 for finalizing a check in operation that was initiated with another compute device (e.g., the mobile compute device 330). The method 400 begins with block 402, in which the check in compute device 100 determines whether a check in request has been received. Referring briefly to FIG. 7, in an initial operation 700, the check in compute device 100 may display a prompt 710 welcoming a user (e.g., the guest 390) and present a set of user interface elements (e.g., selectable icons) 712, 714, 716, 718 available for selection by the user (e.g., the guest 390). The user interface element 712 represents an option to complete the check in process. Further, the user interface elements 714, 718 represent an option to request assistance (e.g., from the check in compute device 100, from a remote assistant (e.g., at a remote assistant compute device 360, 362), or from personnel working at the hotel (e.g., the hotel 310)). Further, the user interface element 716 represents an option to select a language in which information is presented by the check in compute device 100. The check in compute device 100 may determine that a check in request has been received in response to detecting that a user (e.g., the guest 390) has selected the user interface element 712 shown in FIG. 7, indicating that the guest 390 wishes to complete the check in process and obtain a key to access corresponding room(s) of the hotel (e.g., the hotel 310). In other embodiments, the check in compute device 100 may determine that a check in request has been received based on other factors. For example, the check in compute device 100 may continually capture images using the image capture device 120 and determine that a check in request has been received merely by detecting that a guest (e.g., the guest 390) is standing in front of the check in compute device 100 (e.g., without requiring the guest 390 to affirmatively select a user interface element indicating a desire to obtain a room key).

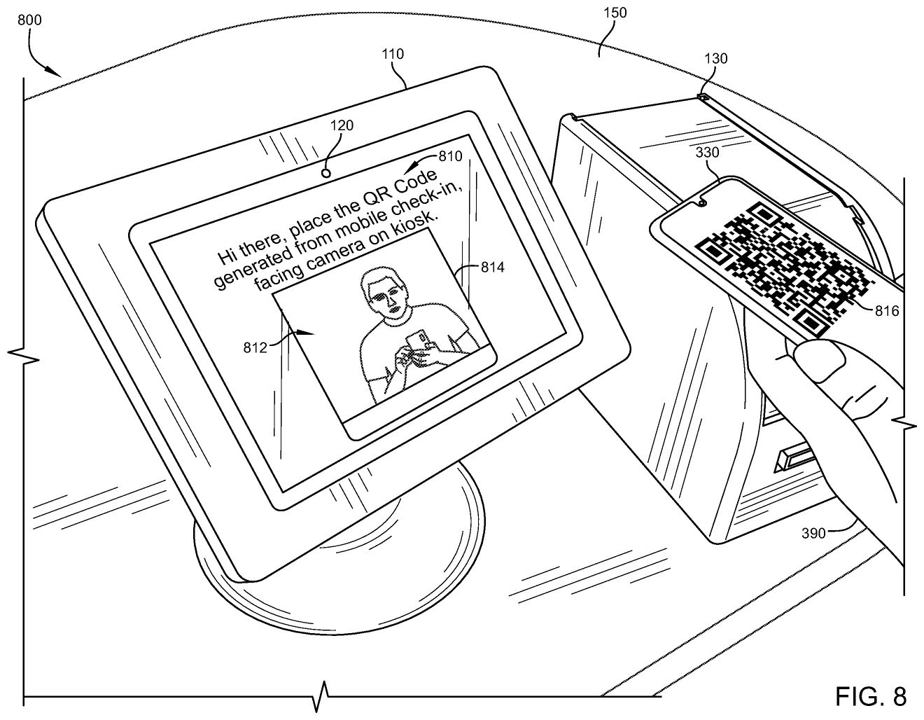

In response to a determination to perform the check in process, the method 400 advances to block 404, in which the check in compute device 100 presents a prompt for a guest (e.g., the guest 390) to present a visual code indicative of authorization to check in to a hotel (e.g., the hotel 310). In doing so, and as indicated in block 406, the check in compute device 100 may display a feed (e.g., a series) of images captured by an image capture device of the check in compute device 100 (e.g., the image capture device 120). Further, the check in compute device 100 may display a frame indicative of an area in which the visual code should be positioned by the guest 390 (e.g., to be imaged by the image capture device 120), as indicated in block 408. Referring briefly to FIG. 8, in the operation 800, the check in compute device 100 displays the prompt 810 for the guest 390 to present the visual code 816. The check in compute device 100 displays a feed 812 of images captured by the image capture device 120 and additionally displays a frame 814 indicating the area of the environment within the field of view of the image capture device 120 in which the guest 390 should position the visual code 816 to be imaged (e.g., seen) by the image capture device 120.

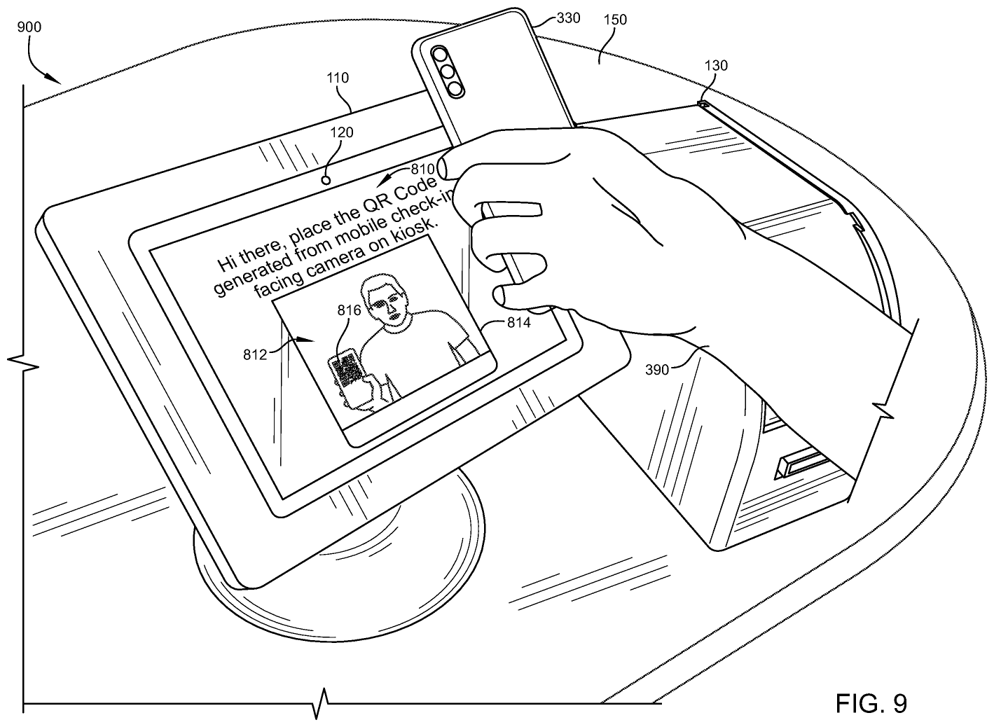

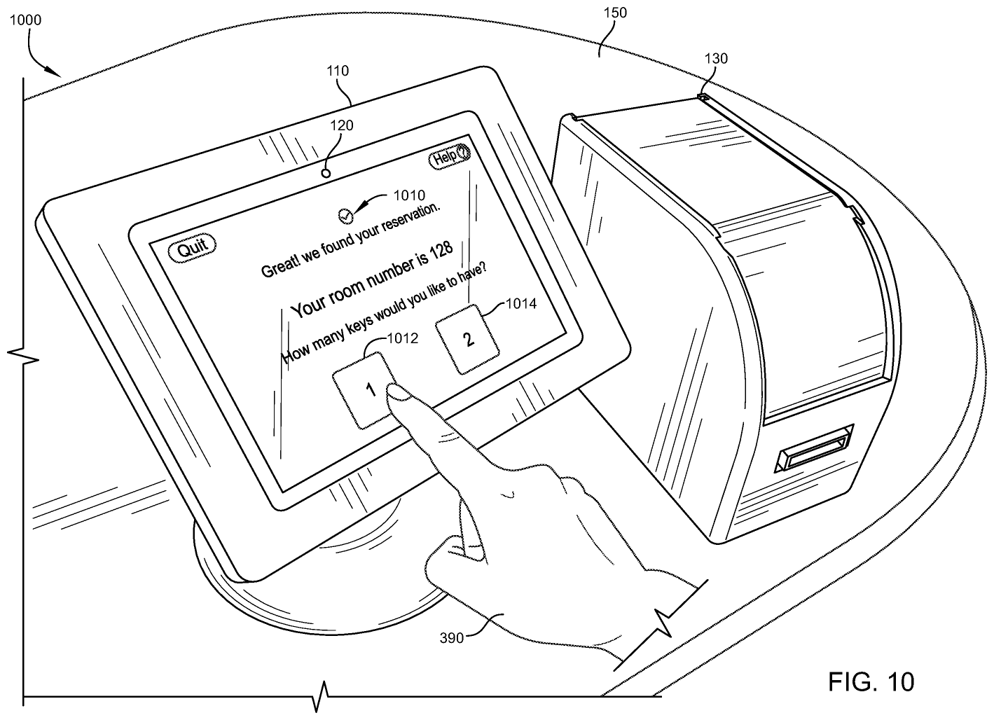

In block 410, the check in compute device 100 receives, using the image capture device 120, an image of the visual code indicative of authorization to check in to the hotel (e.g., the hotel 310). In doing so, in the illustrative embodiment, the check in compute device 100 receives an image of a visual code indicative of a completed pre-check in operation (e.g., performed using the mobile compute device 330 of the guest 390), as indicated in block 412. As indicated in block 414, the check in compute device 100 receives an image of a visual code displayed by a mobile compute device of the guest (e.g., the mobile compute device 330 of the guest 390). In some embodiments, the check in compute device 100 receives an image of a bar code, as indicated in block 416 (e.g., the visual code may be a bar code). The check in compute device 100, in some embodiments of the method 400, receives an image of a quick response (QR) code, as indicated in block 418 (e.g., the visual code may be a QR code, which is a two dimensional bar code). Referring briefly to FIG. 9, in the operation 900 which corresponds to block 410 of the method 400, the check in compute device 100 displays the visual code 816 within the frame 814 as captured by the image capture device 120.

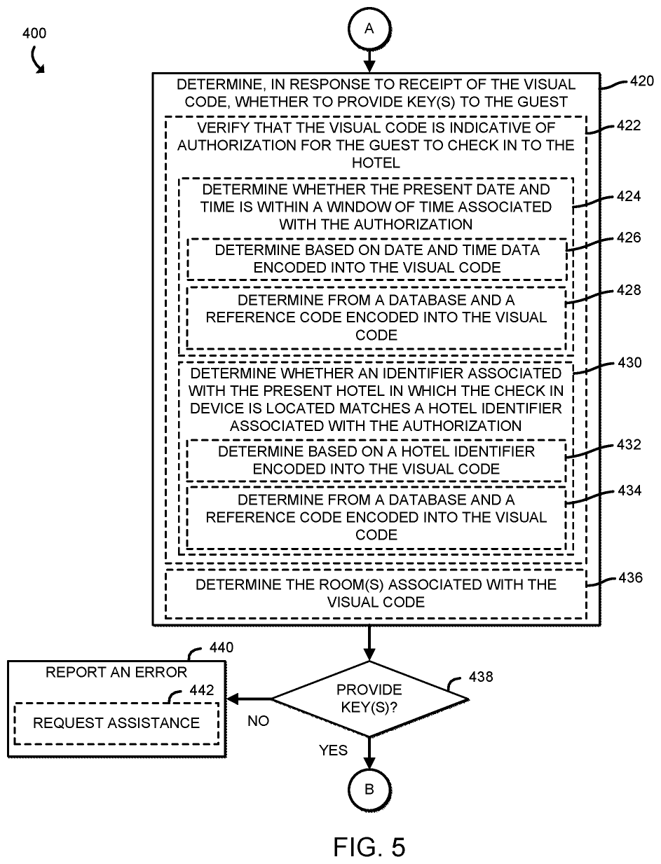

Continuing the method 400 and referring now to FIG. 5, the check in compute device 100 determines, in response to receipt of the visual code, whether to provide one or more keys to the guest 390, as indicated in block 420. In doing so, and as indicated in block 422, the check in compute device 100 may verify that the visual code is indicative of authorization for the guest 390 to check in to the hotel (e.g., the hotel 310). In performing the verification, the check in compute device 100 may determine whether the present date and time (e.g., the date and time at which the visual code was received by the check in compute device 100) is within a window of time associated with the authorization (e.g., within the time period that the room(s) of the hotel are reserved for the guest 390), as indicated in block 424. The check in compute device 100 may, in some embodiments, make the determination based on date and time data encoded into the visual code (e.g., the visual code itself includes data identifying the date and time range (e.g., the window of time) associated with the reservation), as indicated in block 426. In other embodiments, the check in compute device 100 may make the determination from a database and a reference code encoded into visual code, as indicated in block 428. That is, in some embodiments, rather than decoding date and time data from the visual code itself, the check in compute device 100 decodes a reference code (e.g., a unique identifier) that the check in compute device 100 then includes in a query to a database of reservation data (e.g., indexed based on reference codes) to obtain the window of time associated with the reservation. The database may be local to the check in compute device 100 (e.g., in the memory 214 or data storage 218) or may be in another compute device (e.g., a server compute device 340, 342 in the data center 350).

Referring now to block 430, the check in compute device 100 may determine whether an identifier associated with the present hotel (e.g., the hotel 310) in which the check in compute device 100 is located matches (e.g., is equal to) a hotel identifier associated with the authorization. In doing so, and as indicated in block 432, the check in compute device 100 may make the determination based on a hotel identifier encoded into the visual code. Alternatively, and as indicated in block 434, the check in compute device 100 may make the determination from a database and a reference code encoded into the visual code. That is, the check in compute device 100 may decode a reference code (e.g., a unique identifier) that the check in compute device 100 then includes in a query to a database of reservation data (e.g., indexed based on reference codes) to obtain the identifier of the hotel associated with the reservation. In either case, after obtaining the hotel identifier associated with the visual code (e.g., either by decoding it directly from the visual code or requesting it from a database based on a reference code in the visual code), the check in compute device 100 may then compare the obtained hotel identifier with an identifier (e.g., in the memory 214 or data storage 218) of the hotel 310 in which the check in compute device 100 is located to determine whether there is match. The hotel identifier may be an address, a name, or other unique sequence of numbers, letters, or other characters. As indicated in block 436, the check in compute device 100, in the illustrative embodiment, additionally determines the one or more room(s) associated with the visual code, either by decoding one or more room identifiers from the visual code itself or by retrieving the room identifier(s) from a database (e.g., in the memory 214 or data storage 218 of the check in compute device 100 or another compute device 340, 342) based on a reference code present in the visual code.

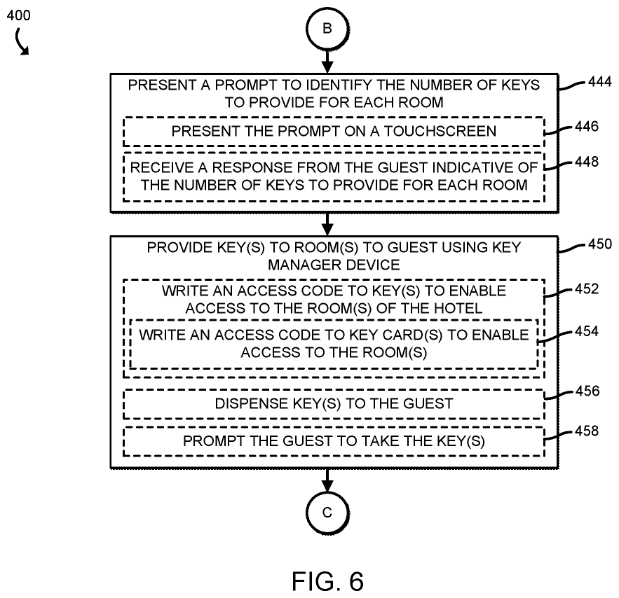

In block 438, the check in compute device 100 determines the subsequent course of action based on the determination in block 420 of whether to provide one or more keys to the guest 390. In the illustrative embodiment, if any of the verifications in blocks 422 and 430 failed or if the check in compute device 100 was unable to determine the room(s) associated with the visual code in block 436, then the method 400 advances to block 440, in which the check in compute device 100 reports an error (e.g., via the display device 110 and/or to another compute device of the system 300 via the network 380). Additionally, the check in compute device 100 may request assistance (e.g., from a remote assistant associated with a remote assistant compute device 360, 362 in the remote assistance center 370), as indicated in block 442. In response to requesting assistance, a remote assistant at a remote assistant compute device 360, 362 may initiate a communication session (e.g., a video communication session) with the guest 390 via the check in compute device 100 to resolve the issue. In response to a determination to provide key(s) to the guest 390, the method 400 advances to block 444 of FIG. 6, in which the check in compute device 100 presents a prompt to identify (e.g., for the guest 390 to identify) the number of keys to provide for each room associated with the reservation. In doing so, the check in compute device 100, in the illustrative embodiment, presents the prompt on a touchscreen (e.g., the display device 110 may be embodied as a touchscreen), as indicated in block 446. In block 448, the check in compute device 100, in the illustrative embodiment, receives a response from the guest 390 that is indicative of the number of keys to provide for each room. Referring briefly to FIG. 9, in an operation 1000 corresponding to block 444 of the method 400, the check in compute device 100 displays a prompt 1010 for the guest 390 to identify the number of keys to provide for each room. As shown, the check in compute device 100 displays, on the display device 110, a user interface element (e.g., an icon) 1012 that, if selected, indicates that the guest 390 would like one key per room and another user interface element 1014 (e.g., another icon) that, if selected, indicates that the guest 390 would like two keys per room. As shown, the guest 390 has selected user interface element 1012, indicating that the guest 390 wants only one key per room.

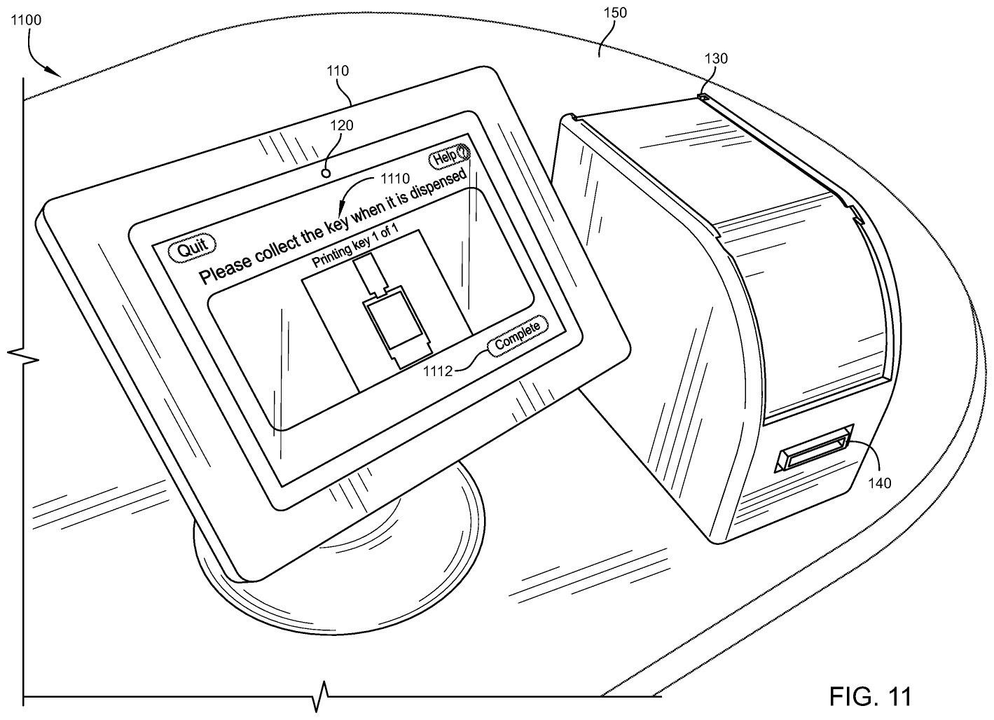

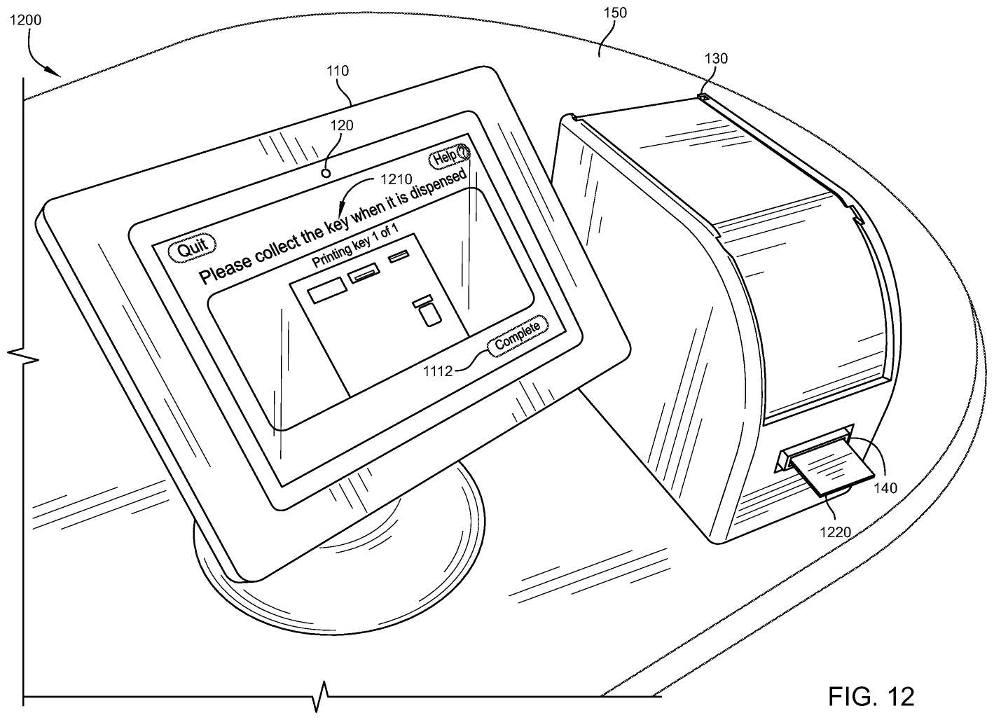

Referring back to FIG. 6, the check in compute device 100 provides one or more room keys (e.g., the number of keys indicated by the guest 390 in block 448) to the guest 390 using the key management device 130, as indicated in block 450. In doing so, and as indicated in block 452, the check in compute device 100 may write an access code to each key to enable access to the corresponding room of the hotel (e.g., the hotel 310). In doing so, and as indicated in block 454, the check in compute device 100 writes, using the key management device 130, an access code to one or more key cards to enable access to the room(s). That is, in the illustrative embodiment, each key is embodied as a card. Further, the check in compute device 100 dispenses each key to the guest, as indicated in block 456. Additionally, the check in compute device 100 may prompt the guest to take the key(s), as indicated in block 458. Referring now to FIG. 11, in an operation 1100 corresponding to block 450 of the method 400, the check in compute device 100 displays a prompt 1110 for the guest 390 to take the key(s). In some embodiments, the check in compute device 100 waits for the guest 390 to acknowledge the prompt 1110 by pressing a corresponding user interface element (e.g., an icon) 1112 prior to dispensing the key(s). Referring now to FIG. 12, in an operation 1200, the check in compute device 100 dispenses each key 1220 via a slot 140 of the key management device 130. In the illustrative embodiment, after dispensing each of the keys 1220, the method 400 loops back to block 402 of FIG. 4 to determine whether another check in request has been received (e.g., for another guest). While the method 400 has been described with reference to a single check in compute device 100 performing the operations in a hotel (e.g., on a table top or surface 150 of another supporting structure in the hotel 310), it should be understood that instances of the method 400 could be performed concurrently by multiple check in compute devices 100 (e.g., check in compute devices 320, 322) that are added to or removed from a check in area (e.g., a lobby) of the hotel (e.g., the hotel 310) on an as needed basis (e.g., to provide increased or decreased throughput for checking in guests).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. Further, it should be understood that while the methods and systems are described above in connection with reservation of rooms in a hotel, it is contemplated that the systems and methods may be used for efficiently checking in to other facilities or locations (e.g., hospitals, resorts, etc.). There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device for use in checking in a guest at a hotel, comprising a touchscreen display device; an image capture device; a key management device; and circuitry configured to present, with the touchscreen display device, a prompt for a guest to present a visual code indicative of authorization to check in to a hotel; receive, with the image capture device, an image of the visual code indicative of authorization to check in the guest to the hotel; determine, in response to receipt of the visual code, whether to provide one or more keys to the guest; and provide, in response to a determination to provide one or more keys to the guest and with the key management device, the one or more keys to the guest, wherein the touchscreen display device, the image capture device, and the key management device are adapted to be supported above a floor of the hotel by a planar surface of a supporting structure.

Example 2 includes the subject matter of Example 1, and wherein the supporting structure is a piece of office furniture.

Example 3 includes the subject matter of any of Examples 1 and 2, and wherein the supporting structure is a desk, a table, or a counter.

Example 4 includes the subject matter of any of Examples 1-3, and wherein the key management device has a separate housing from the touchscreen display device and the image capture device.

Example 5 includes the subject matter of any of Examples 1-4, and wherein the image capture device is integrated with the touchscreen display device.

Example 6 includes the subject matter of any of Examples 1-5, and wherein to receive a visual code comprises to receive an image of a visual code indicative of a completed pre-check in operation performed on a mobile compute device of the guest.

Example 7 includes the subject matter of any of Examples 1-6, and wherein to receive an image of the visual code comprises to receive an image of a visual code displayed by a mobile compute device of the guest.

Example 8 includes the subject matter of any of Examples 1-7, and wherein to receive an image of the visual code comprises to receive an image of a bar code.

Example 9 includes the subject matter of any of Examples 1-8, and wherein to receive an image of the visual code comprises to receive an image of a quick response code.

Example 10 includes the subject matter of any of Examples 1-9, and wherein to determine whether to provide the one or more keys comprises to verify that the visual code is indicative of authorization for the guest to check in to the hotel before providing the one or more keys to the guest. 11. The compute device of claim 10, wherein the circuitry is further configured to determine one or more hotel rooms associated with the visual code.

Example 12 includes the subject matter of any of Examples 1-11, and wherein the circuitry is further configured to determine whether a present date and time at which the visual code is received by the image capture device is within a window of time associated with the authorization for the guest to check in to the hotel.

Example 13 includes the subject matter of any of Examples 1-12, and wherein the circuitry is further configured to determine whether an identifier associated with the hotel in which the compute device is located matches a hotel identifier associated with the authorization.

Example 14 includes the subject matter of any of Examples 1-13, and wherein the circuitry is further configured to write, with the key management device, an access code to each of the one or more keys to enable the guest to access one or more corresponding rooms of the hotel.

Example 15 includes the subject matter of any of Examples 1-14, and wherein to provide the one or more keys to the guest comprises to dispense one or more key cards through a slot in the key management device to the guest.

Example 16 includes the subject matter of any of Examples 1-15, and wherein the circuitry is further configured to display, with the touchscreen display device, a feed of images captured by the image capture device; and indicate, with the touchscreen display device, an area in which the visual code should be positioned by the guest to be received by the image capture device.

Example 17 includes a method for checking in a guest at a hotel, comprising presenting, by a compute device with a display device, a prompt for a guest to present a visual code indicative of authorization to check in to a hotel; receiving, by the compute device and with an image capture device, an image of the visual code indicative of authorization to check in the guest to the hotel; determining, by the compute device and in response to receipt of the visual code, whether to provide one or more keys to the guest; and providing, by the compute device and with a key management device, one or more keys to the guest in response to a determination to provide the one or more keys to the guest, wherein the display device, the image capture device, and the key management device are adapted to be supported above a floor of the hotel by a planar surface of a supporting structure.

Example 18 includes the subject matter of Example 17, and wherein receiving a visual code comprises receiving an image of a visual code indicative of a completed pre-check in operation performed on a mobile compute device of the guest.

Example 19 includes the subject matter of any of Examples 17 and 18, and wherein receiving an image of the visual code comprises receiving an image of a visual code displayed by a mobile compute device of the guest.

Example 20 includes the subject matter of any of Examples 17-19, and wherein receiving an image of the visual code comprises receiving an image of a bar code.

Example 21 includes the subject matter of any of Examples 17-20, and wherein receiving an image of the visual code comprises receiving an image of a quick response code.

Example 22 includes the subject matter of any of Examples 17-21, and wherein determining whether to provide the one or more keys comprises verifying that the visual code is indicative of authorization for the guest to check in to the hotel before providing the one or more keys to the guest.

Example 23 includes the subject matter of any of Examples 17-22, and further including determining, by the compute device, one or more hotel rooms associated with the visual code.

Example 24 includes the subject matter of any of Examples 17-23, and further including determining, by the compute device, whether a present date and time at which the visual code is received by the image capture device is within a window of time associated with the authorization for the guest to check in to the hotel.

Example 25 includes the subject matter of any of Examples 17-24, and further including determining, by the compute device, whether an identifier associated with the hotel in which the compute device is located matches a hotel identifier associated with the authorization.

Example 26 includes the subject matter of any of Examples 17-25, and further including writing, with the key management device, an access code to each of the one or more keys to enable the guest to access one or more corresponding rooms of the hotel.

Example 27 includes the subject matter of any of Examples 17-26, and wherein providing the one or more keys to the guest comprises dispensing one or more key cards through a slot in the key management device to the guest.

Example 28 includes the subject matter of any of Examples 17-27, and further including displaying, with the display device, a feed of images captured by the image capture device; and indicating, with the display device, an area in which the visual code should be positioned by the guest to be received by the image capture device.

Example 29 includes one or more machine-readable storage media comprising a plurality of instructions stored thereon that, in response to being executed, cause a compute device that includes a touchscreen display device, an image capture device, and a key management device adapted to be supported above a floor of a hotel by a planar surface of a supporting structure to present, with the touchscreen display device, a prompt for a guest to present a visual code indicative of authorization to check in to the hotel; receive, with the image capture device, an image of the visual code indicative of authorization to check in the guest to the hotel; determine, in response to receipt of the visual code, whether to provide one or more keys to the guest; and provide, in response to a determination to provide one or more keys to the guest and with the key management device, the one or more keys to the guest.

Example 30 includes the subject matter of Example 29, and wherein to receive a visual code comprises to receive an image of a visual code indicative of a completed pre-check in operation performed on a mobile compute device of the guest.

Example 31 includes the subject matter of any of Examples 29 and 30, and wherein to receive an image of the visual code comprises to receive an image of a visual code displayed by a mobile compute device of the guest.

Example 32 includes the subject matter of any of Examples 29-31, and wherein to receive an image of the visual code comprises to receive an image of a bar code.

Example 33 includes the subject matter of any of Examples 29-32, and wherein to receive an image of the visual code comprises to receive an image of a quick response code.

Example 34 includes the subject matter of any of Examples 29-33, and wherein to determine whether to provide the one or more keys comprises to verify that the visual code is indicative of authorization for the guest to check in to the hotel before providing the one or more keys to the guest.

Example 35 includes the subject matter of any of Examples 29-34, and wherein the instructions further cause the compute device to determine one or more hotel rooms associated with the visual code.

Example 36 includes the subject matter of any of Examples 29-35, and wherein the instructions further cause the compute device to determine whether a present date and time at which the visual code is received by the image capture device is within a window of time associated with the authorization for the guest to check in to the hotel.

Example 37 includes the subject matter of any of Examples 29-36, and wherein the instructions further cause the compute device to determine whether an identifier associated with the hotel in which the compute device is located matches a hotel identifier associated with the authorization.

Example 38 includes the subject matter of any of Examples 29-37, and wherein the instructions further cause the compute device to write, with the key management device, an access code to each of the one or more keys to enable the guest to access one or more corresponding rooms of the hotel.

Example 39 includes the subject matter of any of Examples 29-38, and wherein to provide the one or more keys to the guest comprises to dispense one or more key cards through a slot in the key management device to the guest.

Example 40 includes the subject matter of any of Examples 29-39, and wherein the instructions further cause the compute device to display, with the touchscreen display device, a feed of images captured by the image capture device; and indicate, with the touchscreen display device, an area in which the visual code should be positioned by the guest to be received by the image capture device.

1. A compute device for use in checking in a guest at a hotel, comprising:
a touchscreen display device;
an image capture device;
a key management device; and
circuitry configured to:
present, with the touchscreen display device, a prompt for a guest to present a visual code indicative of authorization to check in to a hotel;
receive, with the image capture device, an image of the visual code indicative of authorization to check in the guest to the hotel;
determine, in response to receipt of the visual code, whether to provide one or more keys to the guest; and
provide, in response to a determination to provide one or more keys to the guest and with the key management device, the one or more keys to the guest,
wherein the touchscreen display device, the image capture device, and the key management device are adapted to be supported above a floor of the hotel by a planar surface of a supporting structure.

2. The compute device of claim 1, wherein the supporting structure is a piece of office furniture.

3. The compute device of claim 2, wherein the supporting structure is a desk, a table, or a counter.

4. The compute device of claim 1, wherein the key management device has a separate housing from the touchscreen display device and the image capture device.

5. The compute device of claim 1, wherein the image capture device is integrated with the touchscreen display device.

6. The compute device of claim 1, wherein to receive a visual code comprises to receive an image of a visual code indicative of a completed pre-check in operation performed on a mobile compute device of the guest.

7. The compute device of claim 1, wherein to receive an image of the visual code comprises to receive an image of a visual code displayed by a mobile compute device of the guest.

8. The compute device of claim 1, wherein to receive an image of the visual code comprises to receive an image of a bar code.

9. The compute device of claim 1, wherein to receive an image of the visual code comprises to receive an image of a quick response code.

10. The compute device of claim 1, wherein to determine whether to provide the one or more keys comprises to verify that the visual code is indicative of authorization for the guest to check in to the hotel before providing the one or more keys to the guest.

11. The compute device of claim 10, wherein the circuitry is further configured to determine one or more hotel rooms associated with the visual code.

12. The compute device of claim 10, wherein the circuitry is further configured to determine whether a present date and time at which the visual code is received by the image capture device is within a window of time associated with the authorization for the guest to check in to the hotel.

13. The compute device of claim 10, wherein the circuitry is further configured to determine whether an identifier associated with the hotel in which the compute device is located matches a hotel identifier associated with the authorization.

14. The compute device of claim 1, wherein the circuitry is further configured to write, with the key management device, an access code to each of the one or more keys to enable the guest to access one or more corresponding rooms of the hotel.

15. The compute device of claim 1, wherein to provide the one or more keys to the guest comprises to dispense one or more key cards through a slot in the key management device to the guest.

16. The compute device of claim 1, wherein the circuitry is further configured to:
display, with the touchscreen display device, a feed of images captured by the image capture device; and
indicate, with the touchscreen display device, an area in which the visual code should be positioned by the guest to be received by the image capture device.

17. A method for checking in a guest at a hotel, comprising:
presenting, by a compute device with a display device, a prompt for a guest to present a visual code indicative of authorization to check in to a hotel;
receiving, by the compute device and with an image capture device, an image of the visual code indicative of authorization to check in the guest to the hotel;
determining, by the compute device and in response to receipt of the visual code, whether to provide one or more keys to the guest; and
providing, by the compute device and with a key management device, one or more keys to the guest in response to a determination to provide the one or more keys to the guest,
wherein the display device, the image capture device, and the key management device are adapted to be supported above a floor of the hotel by a planar surface of a supporting structure.

18. The method of claim 17, wherein receiving a visual code comprises receiving an image of a visual code indicative of a completed pre-check in operation performed on a mobile compute device of the guest.

19. The method of claim 17, wherein receiving an image of the visual code comprises receiving an image of a visual code displayed by a mobile compute device of the guest.

20. One or more machine-readable storage media comprising a plurality of instructions stored thereon that, in response to being executed, cause a compute device that includes a touchscreen display device, an image capture device, and a key management device and that is adapted to be supported above a floor of a hotel by a planar surface of a supporting structure, to:
present, with the touchscreen display device, a prompt for a guest to present a visual code indicative of authorization to check in to the hotel;
receive, with the image capture device, an image of the visual code indicative of authorization to check in the guest to the hotel;
determine, in response to receipt of the visual code, whether to provide one or more keys to the guest; and
provide, in response to a determination to provide one or more keys to the guest and with the key management device, the one or more keys to the guest.
